(19) United States
(12) Patent Application Publication
(10) Pub. No.: US 2025/0238535 A1
(43) Pub. Date: Jul. 24, 2025

(54) PRIORITIZING ACCESS BY A CONTAINER INSTANCE TO A FILE IN A FILE SYSTEM RESOURCE

(71) Applicant: Siemens Aktiengesellschaft, München (DE)

(72) Inventor: Christian Knierim, München (DE)

(21) Appl. No.: 18/697,887

(22) PCT Filed: Sep. 28, 2022
(86) PCT No.: PCT/EP2022/076954

§ 371 Date: Apr. 2, 2024

(30) Foreign Application Priority Data
Oct. 19, 2021 (EP) 21203473.0

(51) Int. Cl. G06F 21/62; G06F 21/64

(52) U.S. Cl. CPC G06F 21/6209; G06F 21/64

(57) ABSTRACT

A method for prioritizing access by a container instance to a file in a file system resource is provided, including: receiving, in a runtime environment of the container instance, an access request for the container instance to access the file, the access request comprising an access identifier that denotes at least one property of the accessing container instance, checking the at least one property in the access identifier against an access guideline, which includes a prioritization level for accessing at least the one file on the basis of the properties of the access identifier, by way of an access control unit in the container runtime environment, and allocating an access permission with a prioritization level relating to the access request on the basis of the result of the check, forwarding the access request to the file on the basis of the allocated prioritization level.

### CROSS-REFERENCE TO RELATED APPLICATIONS

This application claims priority to PCT Application No. PCT/EP2022/076954, having a filing date of Sep. 28, 2022, which claims priority to EP Application Serial No. 21203473.0, having a filing date of Oct. 19, 2021, the entire contents both of which are hereby incorporated by reference.

### FIELD OF TECHNOLOGY

The following relates to a method for prioritizing access by a container instance to a file in a file system resource.

### BACKGROUND

Container virtualization is a method in which a plurality of instances of an operating system can use an operating system core of a host computer in a manner isolated from one another. Software containers, called containers for short below, are therefore a lightweight way of virtualizing a runtime environment on a host computer, also called host system, and cut off an SW application operated in a container from the underlying host system. SW applications or the services provided by SW applications are now implemented by containers in many sectors, for example industrial automation and process control, or else for applications in transport systems or vehicles.

In order to be able to start a container on the host system, a container image is required, which container image also contains, in addition to the application software, the binary programs and libraries required for the application software. A container, more specifically a container instance, is created from the container image on the host system and is executed in the runtime environment. If necessary, for example if the application is called to an increased extent by users, further container instances may be generated from the same container image on the same host system or on another host system and executed.

Container instances are conventionally operated with the aid of a container runtime environment, for example a “docker” in the operating system of the host system, which is possibly also in the form of virtualized hardware resources. Files or file system areas on a memory resource provided by the host system, which the container instance or a process carried out in the container instance wishes to access, are assigned to the container instance, for example during starting, and authorizations to access these files are assigned.

The operating system of the host system uses the access authorizations assigned for the file to control which processes gain access to this file. In this case, a plurality of container instances of the same container image may be operated in a parallel manner on a host system and may also access the file assigned to the respective container instance in a parallel manner. Container instances of different container images may also use the same file. In both cases, it is also necessary in many cases for write accesses to the file to be serialized. As soon as operations of writing to the file take place, it must be ensured that a writing process exclusively carries out the accesses for the desired period of time.

CN 112 580 086 A describes an access protection method for a configuration file. The access method is carried out in isolation by an application in a container. In order to avoid conflicts between a plurality of requests to write to the configuration file, the write requests are placed in the request queue according to a predetermined queue mechanism, for example in the order in which the write request is received or according to a priority of the write request. The request parameters from each write request in the queue are then sequentially written to the configuration file.

SIEMENS AG CHRISTIAN KNIERIM DE-MÜNCHEN ET AL.: “Definition und Überprüfung von Komplexitätsregeln für vertrauliche Informationen in Container-Instanzen [Definition and checking of complexity rules for confidential information in container instances]”, PRIOR ART PUBLISHING GMBH, MANFRED-VON-RICHTHOFEN-STR. 9, 12101 BERLIN GERMANY, vol. www.priorartregister.com, Jul. 15, 2021 (2021 Jul. 15), pages 1-5, XP007024163, describes a method for checking complexity requirements and complexity rules for confidential information, which method automatically detects the criticality of a runtime parameter and carries out complexity checks on the basis of this detection.

US 2020/326984 A1 discloses a docker-container-oriented method for isolating file system resources. In embodiments, the method uses an isolation-related “lock” competition in shared operating system cores and a competition for file system resources that allocates host file system resources according to access requests from containers and checks lock resources according to the access requests.

There is therefore the need for a solution which ensures that the writing resource utilization of a device file is serialized for individual instances or container images and is restricted, delayed or prioritized depending on the confidence level or properties thereof. If, in the worst-case scenario, a container instance blocks a device file over the permitted duration or permanently accesses it, it should also be ensured that such an instance is terminated.

### SUMMARY

An aspect relates to a method which ensures that the writing resource utilization of a file is serialized for individual container instances or container images and is restricted, delayed or prioritized depending on the properties thereof.

According to an aspect, embodiments of the invention relate to a method for prioritizing access by a container instance to a file in a file system resource, comprising
receiving, in a runtime environment of the container instance, an access request for the container instance to access the file, wherein the access request contains an access identifier which indicates at least one property of the accessing container instance,
checking, by way of an access control unit in the container runtime environment, the at least one property in the access identifier against an access guideline that comprises a prioritization level for accessing at least the one file on the basis of the properties of the access identifier, and
assigning an access authorization with a prioritization level to the access request on the basis of the checking result,
forwarding the access request to the file on the basis of the assigned prioritization level.

This makes it possible to set up and enforce authorizations to access the files that are specific to the container instance. The access identifier may be in the form of a label, that is to say a skip mark. The properties in the access identifier may be stored in a memory area indicated by the skip mark and provided for checking. Prioritization levels which indicate a processing order for accessing the file may be linked to the properties of the container instance via the access guideline. Access authorizations can therefore be flexibly allocated and enforced.

In an embodiment, the file is a device file which receives control instructions from the container instance and forwards them for execution to a hardware resource that can be controlled by the container instance.

The hardware resource is assigned to the container instance, for example when starting the container instance, by a configuration file. The hardware resource is also referred to as a device below. As soon as processes in the container instance would like to transmit control instructions to a device, the container instance transfers the control instructions to the device file which was generated in the file system. The device file forwards the control instructions to the controller which translates them into device-specific control commands. A prioritized access authorization to the device can therefore be specifically provided for the container instance by way of the access identifier of the container instance in the access request.

In an embodiment, the access identifier is created specifically for the container instance. Alternatively, the access identifier is created specifically for the container image and the container-image-specific access identifier is assigned to each container instance generated from the container image.

A prioritization of the access authorization can therefore be specifically set up for each individual container instance. If the access identifier is created specifically for a container image, the same access authorizations can be easily defined and enforced for all container instances created from the container image.

In an embodiment, the prioritization levels for accessing the hardware resource by the accessing container instance are predefined by an operator of the hardware resource.

The operator of the HW resource or of the associated device, which is not necessarily an integral part of the host system, can therefore influence permitted access rights of accessing container instances.

In an embodiment, a property in the access identifier is at least one from a selection of: a name of the access identifier, a signature of the accessing container instance, a signature of the container image, from which the accessing container instance is generated, and/or a name of the container image.

A confidence level can be derived from the signature of the container instance or of the container image. A prioritization level for the authorization to access the file or device file may be assigned to each property in the selection via the access guideline. Access authorizations can therefore be flexibly linked to different properties.

In an embodiment, at least one network interface is assigned to the container instance, and the access identifier contains an identifier for each of the at least one assigned network interface.

A prioritized access authorization can therefore be effected on the basis of the affiliation of the container instance with a network interface.

In an embodiment, the identifier of the assigned network interface is assigned to the network interface by an operator of the container runtime environment.

The operator of the container runtime can therefore control access to the network interface by a container instance.

In an embodiment, the access guideline comprises a prioritization level for each of the identifiers of the network interfaces.

The prioritization level of the access authorization can therefore be set up in a fine-tuned manner on the basis of each individual network interface.

In an embodiment, that prioritization level which is assigned in the access guideline to the first property contained in the access identifier is assigned to the access request.

If a plurality of network interfaces are assigned to a single container instance, for example, the priority level for accessing the device file is predefined by the network interface mentioned first in the access identifier. The priority level for accessing the device file can therefore be predefined by a specific order of the properties in the access identifier.

In an embodiment, the highest prioritization level of all prioritization levels assigned to the properties contained in the access identifier is assigned to the access request.

This enables an alternative interpretation of the access identifier.

In an embodiment, the access guideline comprises, for each of the at least one file, a name of the file and at least one property from a selection of the following properties: a name of the access identifier, a signature of the accessing container instance, a signature of the container image, from which the accessing container instance is generated, a name of the container image or an identifier for a network interface, and a prioritization level is assigned to at least one of the properties from the selection.

The properties are assigned to a prioritization level in the access guideline. If a high priority level is assigned to the identifier of a network interface of the container instance, the access request is given preferential treatment over an access request from a container instance, the network interface of which is assigned to a low prioritization level.

In an embodiment, the access guideline comprises, for each of the at least one file, at least one detail from a selection of: a process name for a process requested via the access request, an access mode, a maximum access duration, for example, on the basis of the properties of the access identifier.

The access guideline can therefore specify the access mode for each file, that is to say whether parallel write access to the HW resource is allowed or exclusive access, that is to say serial write access. If parallel write access is allowed, a maximum number of write actions that take place in a parallel manner can be defined. The access mode indicates, for example, whether parallel access only by container instances of the same container image or by container instances of different container images is allowed.

In an embodiment, the access control unit is in the form of an expansion module in the container runtime environment or in the form of an independent unit that is separate from the container runtime.

Forming the access control unit as an expansion module makes it possible to quickly prioritize the access authorizations on the host system. Forming the access control unit as an independent unit means that the process is cut off better from the container runtime environment and can also be incorporated by further runtime environments running in a parallel manner. Alternatively, the access control unit can be distributed, via a central deployment system, for example with the aid of an orchestrator, among all systems managed by the orchestrator.

A further aspect of embodiments of the invention relate to an apparatus for prioritizing access by a container instance to a file in a file system resource, comprising a runtime environment of a container instance, which is designed
to receive an access request for the container instance to access the file, wherein the access request contains an access identifier which indicates at least one property of the accessing container instance,
to check, by way of an access control unit in the container runtime environment, the at least one property in the access identifier against an access guideline that comprises a prioritization level for accessing at least the one file on the basis of the properties of the access identifier, and
to assign an access authorization with the prioritization level to the access request on the basis of the checking result, and
to forward the access request to the file on the basis of the assigned prioritization level.

As a result of the apparatus according to embodiments of the invention, a plurality of container instances can access the same file at the same time and can be prioritized.

A further aspect of embodiments of the invention relate to a computer program product (non-transitory computer readable storage medium having instructions, which when executed by a processor, perform actions) comprising a non-volatile computer-readable medium which can be loaded directly into a memory of a digital computer, comprising program code parts which, when the program code parts are executed by the digital computer, cause the latter to carry out the steps of the method.

Unless stated otherwise in the following description, the terms “receive”, “check”, “assign”, “forward” and the like relate to actions and/or processes and/or processing steps which change and/or generate data and/or convert the data into other data, wherein the data are presented or may be present, in particular, as physical variables, for example as electrical pulses. The apparatus and the runtime environment contained therein may comprise one or more processors.

A computer program product, for example a computer program means, may be provided or delivered, for example, as a storage medium, for example a memory card, a USB stick, a CD-ROM, a DVD or in the form of a downloadable file from a server in a network. This may be effected, for example in a wireless communication network, by transmitting a corresponding file to the computer program product or the computer program means.

### BRIEF DESCRIPTION

Some of the embodiments will be described in detail, with references to the following Figures, wherein like designations denote like members, wherein:

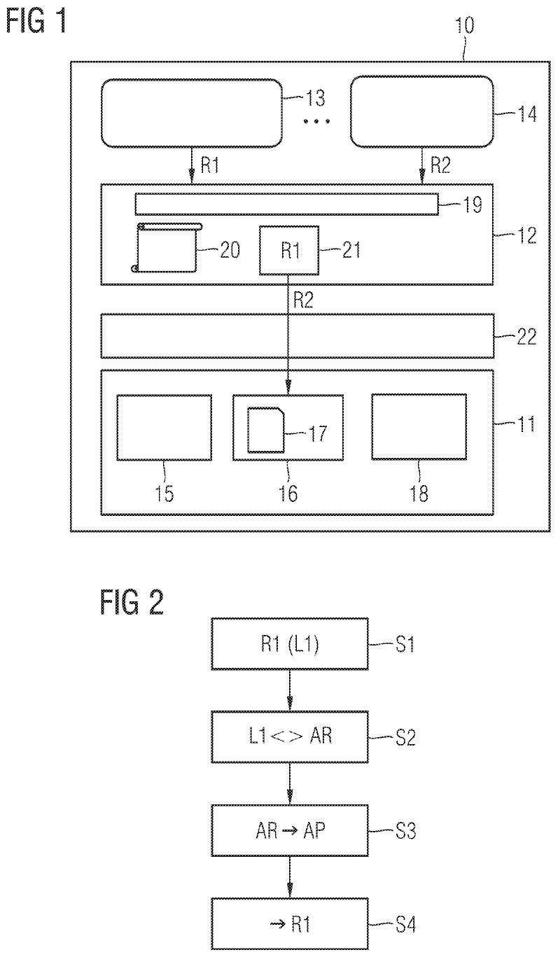

FIG. 1 shows a schematic illustration of an exemplary embodiment of the system in the form of a host system with a runtime environment;

FIG. 2 shows an exemplary embodiment of the method as a flowchart;

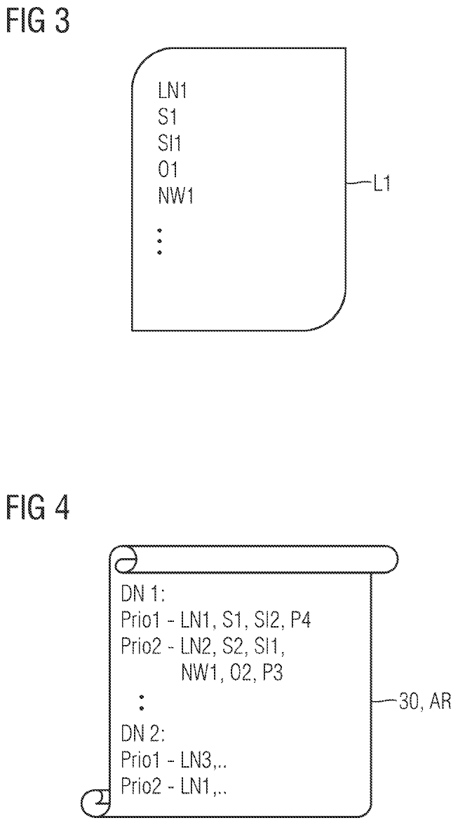

FIG. 3 shows a schematic illustration of an exemplary embodiment of an access identifier; and

FIG. 4 shows a schematic illustration of an exemplary embodiment of the access guideline.

### DETAILED DESCRIPTION

The individual components of the system according to embodiments of the invention and interaction of the container instance and access to a file assigned to the container instance are shown using FIG. 1.

FIG. 1 shows a system 10 having HW resources 11, an operating system with a container runtime environment 12 and two container instances 13, 14 executed in the container runtime environment 12. HW resources 11 are, for example, a control device 15, a memory unit 16 or a network interface 18 physically formed in the system. The network interface may also be in the form of a virtual network interface. The physical network interface and the virtual network interface are addressed via the operating system kernel 22. A file 17 is stored in a file system in the memory unit 16. The file 17 is assigned to the container instance 13 and can therefore be accessed by virtue the file 17 being incorporated, by a “bind-mount” command, into a mount namespace of the container instance 13 or by sharing another mount namespace that the file 17 has.

If the container instance 13 or a process executed on the instance would like to access a file 17, the operating system or the container runtime environment 12 controls which processes gain access to the file on the basis of access authorizations.

If a plurality of container instances of the same container image are operated in a parallel manner on a host system, these container instances conventionally also access the file assigned to each of these container instances in a parallel manner. This is the case, in particular, if orchestration solutions such as Kubernetes detect and scale up an overload situation for container instances that are already being operated, that is to say generate and start further container instances from the same container image. If too many container instances are started, it may be the case that, as a result of the scaling up, too many accesses to the file are granted and the file can no longer be correctly processed.

Container instances of different container images may also use the same file and carry out different tasks on the same controller. These container images may also be provided by different manufacturers and do not always have the same confidentiality level. If the file 17 is a device file which receives control instructions from the container instance 13 and forwards them for execution to a hardware resource 11 that can be controlled by the container instance 13, for example the control device 15, a malicious container instance in a conventional system can use a control device 15 connected to the device file, by permanently writing to the device file, in such a manner that control signals from other container instances that are relevant to operational reliability, for example, can no longer be transmitted and the reliability of the host system or of an installation, in which the container instance is operated via a cloud-based host system, is therefore jeopardized.

In both cases, it is also often necessary for write accesses to the file to be serialized, that is to say for write operations to be carried out in temporal succession and not at the same time.

A fundamental concept is for container instances 13, 14 to have certain properties and for access to a file 17 to be prioritized on the basis of one or more of these properties.

In embodiments, the method according to embodiments of the invention for prioritizing access by a container instance, for example container instance 13, to a file, for example the file 17, in a file system resource, for example memory unit 16, is illustrated in FIG. 2.

In a first method step S1, the runtime environment 12 of the container instance 13 receives an access request R1 for the container instance 13 to access the file 17. The access request contains an access identifier L1 which indicates at least one property of the accessing container instance 13. The file 17 may be any type of file, but, in particular, may also be a device file. The access identifier L1 is created specifically for the container instance 13, with the result that each container instance 13 is assigned its own, for example unique, access identifier L1. The access identifier L1 may also be created specifically for the container image, with the result that the same container-image-specific access identifier is assigned to each container instance generated from the same container image.

In the next method step S2, the at least one property in the access identifier L1 is checked against an access guideline 20, AR and a prioritization level for accessing the file 17 is determined by an access control unit 19 in the container runtime environment 12 on the basis of the properties of the access identifier L1 with reference to the access guideline 20, AR. An access authorization with the prioritization level AP resulting from the check is then assigned to the access request R1, see method step S3. The access request R1 is placed in a queue 21, for example, according to the prioritization level AP, for transfer to the file 17. The access request R1 is then forwarded to the file 17 on the basis of the assigned prioritization level AP.

If the file 17 is a device file, the prioritization level AP for accessing the hardware resource that can be addressed by the device file, for example the control device 15, can be predefined by an operator of the hardware resource and therefore the manufacturer of the control device 15.

The access control unit 19 is in the form of an expansion module of the container runtime environment 12 in the system 10 or in the form of an independent unit that is separate from the container runtime. The system 10 with the runtime environment 12 is designed to carry out the described method.

FIG. 3 illustrates an exemplary embodiment for the access identifier L1. The access identifier L1 of the container instance 13 comprises at least one of the properties of the container instance 13. In this case, properties may be, in particular, a name LN1 of the access identifier L1, a signature S1 of the container instance 13, a signature SI1 of the container image, from which the accessing container instance 13 is generated, or a name O1 of the container image. If one or more network interfaces are assigned to the container instance 13, the access identifier may comprise an identifier NW1 for each of the assigned network interfaces. The identifier NW1 is for example, assigned to the network interface by an operator of the container runtime environment 12.

FIG. 4 shows an exemplary embodiment of an access guideline 30, AR. The access guideline 30, AR comprises, for each of the at least one file 17, a name DN1, DN2 of the respective file and at least one property of the container instances authorized for access. The access guideline also comprises at least one prioritization level Prio1, Prio2. Properties corresponding to the properties contained in the access identifiers are assigned to the at least one prioritization level Prio1, Prio2. The properties contained in the access identifier L1 are therefore checked against the properties in the access guideline 30, AR. That prioritization level Prio1, Prio2 which is assigned to the first property contained in the access identifier, is assigned to the access request. In the case of this procedure which is also referred to as a first-hit method, the prioritization level Prio1, Prio2 which applies to the first property in the access identifier of the container instance is used for a file, for which write access is intended to be regulated. Alternatively, the highest prioritization level of all properties mentioned in the access identifier can also be assigned to the access request.

FIG. 4 shows a selection of possible properties in the access guideline: a name LN1 of the access identifier L1, a signature S1 of the accessing container instance 13, a signature SI1 of the container image, from which the accessing container instance is generated, a name O1 of the container image or an identifier NW1 for a network interface. Each property is assigned to a prioritization level. The access guideline 20, AR also comprises, for each of the at least one file 17, at least one detail from: a process name for a process P3, P4 of the container instance that is requested using the access request, an access mode, a maximum access duration, for example, on the basis of the properties of the access identifier or on the basis of the respective process. It can be stated, for each file 17, whether it is allowed to have parallel write access or exclusive write access. If parallel write access is allowed, a maximum number of write actions that take place in a parallel manner can be defined.

As a result of the network interface identifier NW1, it is possible for the accesses to the file 17 to be prioritized using the affiliation of the container instance with a network interface, also called a network bridge. Network interfaces make it possible to segment container instances on the network side. The access guideline 20, 30, AR can therefore be used to ensure that container instances which are operated in a more critical data network can have a higher priority.

If a container instance is connected to a plurality of network interfaces, the access guideline 20, 30, AR must likewise define whether the rules of the network interface with the lowest prioritization level or the rules of the network interface with the highest priority level are used. For this purpose, the network interfaces must be prioritized accordingly upon creation by an operator of an HW resource, which is addressed via the network interface, or by a configurator of the application executed in the container instance. This is possible by defining the priority of the access identifiers or the properties within the access guideline and/or the order of the properties in the access identifier.

The same also applies to container instances or container images, the access identifier of which contains a plurality of properties of the same type, for example a plurality of signatures.

The access guideline 20, AR is interpreted by an access control unit 19, see FIG. 1, which is implemented as an expansion of the container runtime environment 12 or as an independent component. The access control unit 19 is designed to automatically create, in the event of a request R1 to access the file 17 from a process of the container instance 13, on the basis of the access guideline 20, 30, a monitoring program which generates an alarm via an extended Berkely packet filter (eBPF) interface of an operating system kernel 22 and transmits it to the monitoring component in the access control unit 19. The process is initially temporarily interrupted and suspended, in other words put to sleep, with the aid of an eBPF program.

The access control unit 19 first of all checks whether the process belongs to a container instance for which access was allowed. In order to determine whether a process belongs to the container instance 13, the access control unit 19 can interact either with the container runtime environment 12 via a communication interface, for example a docker socket. Alternatively, the access control unit 19 can register process namespace started in the container runtime environment 12 and can monitor further processes started in this process namespace, for example by eBPF programs.

If a request to access the file 17 is received or when starting the container instance 13, the access control unit 19 determines further information, such as characteristics which belong to a network interface, a container image or a container instance. The access control unit 19 requests this information from the container runtime environment 12, for example via the docker socket or corresponding programming interfaces. The access control unit 19 also determines the interfaces to which a network interface 18 assigned to the container instance 13 is connected. This is determined in advance when adding and removing network interfaces. If the relevant properties, such as container image name or signature, are determined before the file 17 is accessed, for example during starting and in the event of changes or when stopping the container instance 13, the parameters stored in the access guideline 20 for each container instance are buffered in the access control unit 19.

The signature information relating to the container image belonging to a container instance 13 is determined either via the access control unit 19 directly by virtue of the latter directly accessing the cached images and the signature data relating to the container runtime environment 12 and performing this itself or reading the corresponding information from the container runtime environment 12 using appropriate interface commands and trusting that it can carry out a correct check.

If the file 17 can be used exclusively or the maximum number of parallel write processes is not reached, the access control unit 19 informs the operating system, in particular an operating system kernel 22, via the eBPF interface, that the process put to sleep by it can be executed. As soon as the process ends write access to the file 17, the access control unit 19 is likewise informed by the operating system kernel 22 with the aid of defined eBPF programs.

The maximum access duration for a container instance 13 may be defined either globally for the file 17 or for each property in the access identifier. The access control unit 19 monitors the maximum access duration stored in the access guideline 20. If the respective maximum access duration is exceeded, access may still be allowed provided that there is no further access request for the file. If a request to access a device file is involved, longer access may be allowed if there is no further resource request for the HW resource addressed using the device file. If there are further access requests for the file 17, the access control unit 19 can inform the associated container instance 13 to immediately enable access and/or can directly end the process using the device file beyond the permitted period of time. This can be carried out, for example, with the aid of corresponding interprocess communication mechanisms in the operating system.

If parallel write access to the device file is possible, instead of ending the process, it can be only put to sleep again. This is possible since it is assumed that, when the file 17 is used in a parallel manner, the accesses do not have to be serialized, but rather access to the file must be primarily given only to higher-priority container instances, for example container instance 14. If the file 17 is in use and a new process would like to access it, the access control unit 19 checks its priority and assigns it to a process queue 21 generated for its priority. The process queue 21 is processed according to its priority via process scheduling in the kernel 22. As soon as it is possible to access the file 17, the monitoring component in the access control unit 18 ends the sleep state of the process via the eBPF interface and executes the process as described above.

In an extended variant, it is also possible for the access guideline 20, 30 to additionally comprise individual process names. In this variant, it is possible to also expand the access authorization or the described method to non-containerized processes such that they can likewise be prioritized differently.

In embodiments, the method can be used to prioritize and serialize not only write accesses to files. For device files, the method has the advantage that the device is assigned and serialized outside the device driver in a resource assignment component. Device-specific software can be scaled up and down in containers without the need for a device-specific resource control component. Non-container-specific processes can likewise be prioritized in the extended variant. If layer-2 protocol information, for example, is written to a system bus via the device files, individual, system-critical containers in the runtime system can emit control commands in a prioritized manner on the basis of their label, their container network technology or the image name.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for prioritizing access by a container instance to a file in a file system resource, comprising:
receiving, in a runtime environment of the container instance, an access request for the container instance to access the file, wherein the access request contains an access identifier (which indicates at least one property of the ne-container instance;
checking, by way of an access control unit in the container runtime environment, the at least one property in the access identifier against an access guideline that comprises a prioritization level for accessing at least the one file on a basis of the at least one property of the access identifier; and
assigning an access authorization with a prioritization level to the access request on a basis of the checking result, and,
forwarding the access request to the file on a basis of the assigned prioritization level.

2. The method as claimed in claim 1, wherein the file is a device file which receives control instructions from the container instance and forwards the control instructions for execution to a hardware resource that can be controlled by the container instance.

3. The method as claimed in claim 2, wherein the access identifier is created specifically for the container instance, or the access identifier is created specifically for a container image and a container-image-specific access identifier is assigned to each container instance generated from the container image.

4. The method as claimed in claim 2, wherein the prioritization levels for accessing the hardware resource by the container instance are predefined by an operator of the hardware resource.

5. The method as claimed in claim 1, wherein the at least one property in the access identifier is at least one from a selection of: a name of the access identifier, a signature of the accessing container instance, a signature of a container image, from which the container instance is generated, and a name of the container image.

6. The method as claimed in claim 1, wherein if at least one network interface is assigned to the container instance, the access identifier contains an identifier for each of the at least one assigned network interface.

7. The method as claimed in claim 6, wherein the identifier of the assigned network interface is assigned to the at least one network interface by an operator of the container-runtime environment.

8. The method as claimed in claim 6, wherein the access guideline comprises a prioritization level for each of the identifiers of the at least one network interfaces.

9. The method as claimed in claim 1, wherein the prioritization level which is assigned to the first property contained in the access identifier is assigned to the access request.

10. The method as claimed in claim 1, wherein a highest prioritization level of all prioritization levels assigned to the at least one property contained in the access identifier is assigned to the access request.

11. The method as claimed in claim 1, wherein the access guideline comprises, for each of the at least one file, a name of the file and at least one property from a selection of the following properties: a name of the access identifier, a signature of the container instance, a signature of a container image, from which the accessing container instance is generated, a name of the container image or an identifier for a network interface, and a prioritization level is assigned to at least one of the properties from the selection.

12. The method as claimed in claim 1, wherein the access guideline comprises, for each of the at least one file, at least one detail from a selection of: a process name for a process requested via the access request, an access mode, a maximum access duration, on a basis of the at least one property of the access identifier.

13. The method as claimed in claim 1, wherein the access control unit is an expansion module of the runtime environment or an independent unit that is separate from the runtime environment.

14. A system for prioritizing access by a container instance to a file in a file system resource, comprising a runtime environment of a container instance, which is configured
to receive an access request for the container instance to access the file, wherein the access request contains an access identifier which indicates at least one property of the container instance;
to check, by way of an access control unit in the runtime environment, the at least one property in the access identifier against an access guideline that comprises a prioritization level for accessing at least the one file on a basis of the properties of the access identifier; and
to assign an access authorization with the prioritization level to the access request on a basis of the checking, and
to forward the access request to the file a basis of the assigned prioritization level.

15. A computer program product, comprising a computer readable hardware storage device having computer readable program code stored therein, said program code executable by a processor of a computer system to implement a method as claimed in claim 1.
